(19) United States
(12) Patent Application Publication
(10) Pub. No.: US 2016/0319941 A1
(43) Pub. Date: Nov. 3, 2016

(54) BALL VALVE ASSEMBLY

(71) Applicant: GE Aviation Systems LLC, Grand Rapids, MI (US)

(72) Inventor: David Allan DRANSCHAK, Dayton, OH (US)

(21) Appl. No.: 15/103,314

(22) PCT Filed: Dec. 13, 2013
(86) PCT No.: PCT/US2013/074879

§ 371 Date: Jun. 10, 2016

(51) Int. Cl. F16K 5/06; F16K 31/50; F16K 31/163

(52) U.S. Cl. CPC F16K 5/0647; F16K 31/1635; F16K 31/502

(57) ABSTRACT

A ball valve assembly includes a housing having a chamber with an inlet and outlet defining a flow passage, a ball with a through passage, a linear actuator and a rotation converter configured to rotate the ball upon actuation of the linear actuator to control the flow of a fluid through the flow passage.

### BACKGROUND

Ball valves have a housing that defines a flow passage and a ball valve member disposed therein. The ball valve member is typically a sphere having a central through passage. The ball rotates between a closed position, wherein the ball valve member central through passage is not aligned with, nor in fluid communication with, the housing flow passage and an open position, wherein the ball valve member central through passage is at least partially aligned with, and at least in partial fluid communication with, the housing flow passage. The ball through passage may have the same or similar cross-sectional area as the housing flow passage, which minimizes changes (pressure, volume, speed) of the liquid passing through the ball valve.

### BRIEF DESCRIPTION

In one aspect, the innovation relates to a ball valve assembly comprising a housing having a chamber with an inlet and an outlet defining a flow passage, a ball having a through passage, a linear actuator and a rotation converter configured to convert the linear movement of the actuator into rotational movement of the ball so as to substantially align or misalign the through passage with the flow passage.

### BRIEF DESCRIPTION OF THE DRAWINGS

In the drawings:

FIG. 1 is a schematic of a ball valve assembly according to various aspects described herein.

FIG. 2 is a perspective view of a ball valve assembly of FIG. 1 in an open or first position according to various aspects described herein.

FIG. 3 is a sectional view of a ball valve assembly in a closed or second position according to various aspects described herein.

FIG. 4 is a sectional view of a ball valve assembly in an open or first position according to various aspects described herein.

### DETAILED DESCRIPTION

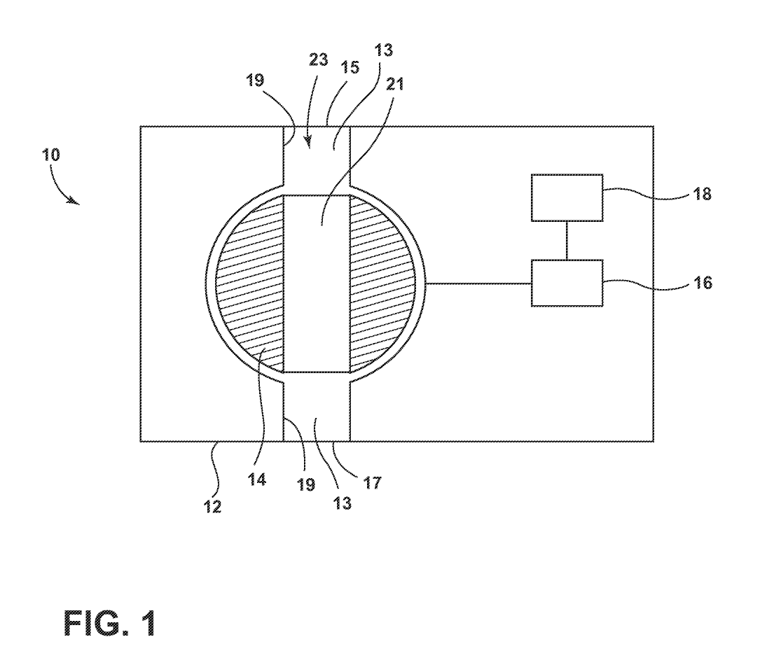

FIG. 1 illustrates a ball valve assembly 10 having a housing 12, a valve body illustrated as a ball 14, a rotation converter 16 and a linear actuator 18 according to a first embodiment of the innovation. The housing 12 defines a chamber 13 having an inlet 15 and an outlet 17 wherein the inlet 15, chamber 13 and outlet 17 define a flow passage 23. The chamber 13 forms a ball seat 19. The ball 14 is disposed within the chamber 13 and seated within the ball seat 19 wherein the inlet 15 and outlet 17 are disposed on opposite sides of the ball 14. A through passage 21 is disposed through the center of the ball 14 with an inlet and outlet to a flow passage 23 on opposite sides of the ball 14. The rotation converter 16 is operably coupled to the ball 14 and the linear actuator 18 is operably coupled to the rotation converter 16, whereby the linear movement of the linear actuator 18 is converted into rotational movement of the ball 14 by the rotation converter 16.

More specifically, the linear actuator 18 is configured to linearly move between at least a first position and a second position. The rotation converter 16 converts the linear movement of the linear actuator 18 into rotational movement, which rotates the ball 14 relative to the ball seat 19. The rotation of the ball 14 rotates the through passage 21 into and out of alignment with the flow passage 23 in the housing 12.

The linear actuator 18 in the second position corresponds to the through passage 21 being substantially misaligned with the flow passage 23, defining a closed position of the ball 14 where no flow through the flow passage 23 is allowed. The linear actuator 18 in the first position corresponds to the through passage 21 being substantially aligned with the flow passage 23, defining an open position ball 14 where flow through the flow passage 23 is allowed. The linear actuator 18 in a position between the first position and second position may correspond to the through passage 21 being partially aligned or misaligned with the flow passage 23, defining a variable position ball 14 where flow through the flow passage 23 is partially allowed. In this way, controlling the actuation of the linear actuator 18 controls the flow through the flow passage 23.

The degree of alignment/misalignment of the through passage 21 with the flow passage 23 controls the volumetric flow rate through the ball valve assembly 10. As previously described, complete alignment of the through passage 21 and flow passage 23 results in maximum flow through the ball valve assembly 10 is achieved, and complete misalignment of the through passage 21 and the flow passage 23 results in no flow through the ball valve assembly 10. In some implementations it is only necessary to have the valve operation as either a fully opened or fully closed condition. However, it is possible to control the amount/degree of alignment such that the ball valve assembly 10 functions as a variable flow rate valve, which has a flow rate corresponding to the amount of alignment.

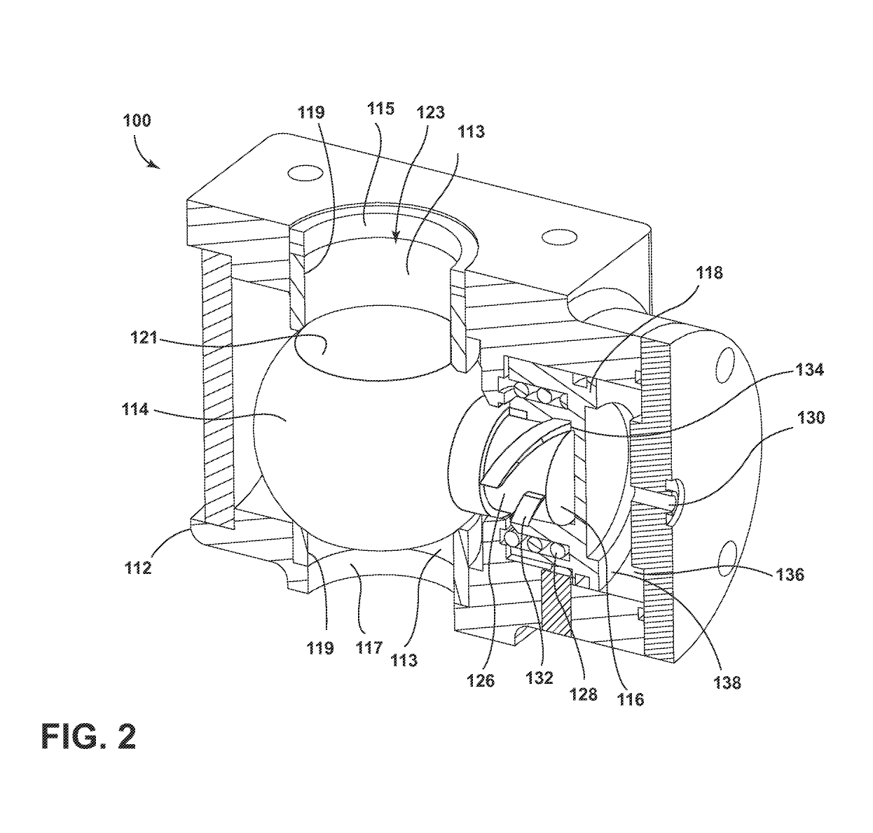

FIG. 2 illustrates a ball valve assembly 100 according to a specific and second embodiment of the innovation. Many parts of the second embodiment of FIGS. 2, 3 and 4 are similar to the first embodiment of FIG. 1. Thus, like parts of the second embodiment will be identified with like numerals of the first embodiment, except the numerals will be increased by 100.

The ball valve assembly 100 is similar to the first embodiment illustrated in FIG. 1 in that it comprises a housing 112, which defines a ball seat 119 in the form of a chamber 113 in communication with an inlet 115 and an outlet 117. The inlet 115, chamber 113 and the outlet 117 define a flow passage 123 through the housing 112. A ball 114 is disposed within the chamber and seated within the ball seat 119 wherein the inlet 115 and outlet 117 are disposed on opposite sides of the ball 114. A through passage 121 is disposed through the center of the ball 114 with an inlet and outlet to a flow passage 123 on opposite sides of the ball 114. The rotation converter 116 is operably coupled to the ball 114 and the linear actuator 118 is operably coupled to the rotation converter 116, whereby the linear movement of the linear actuator 118 is converted into rotational movement of the ball 114 by the rotation converter 116.

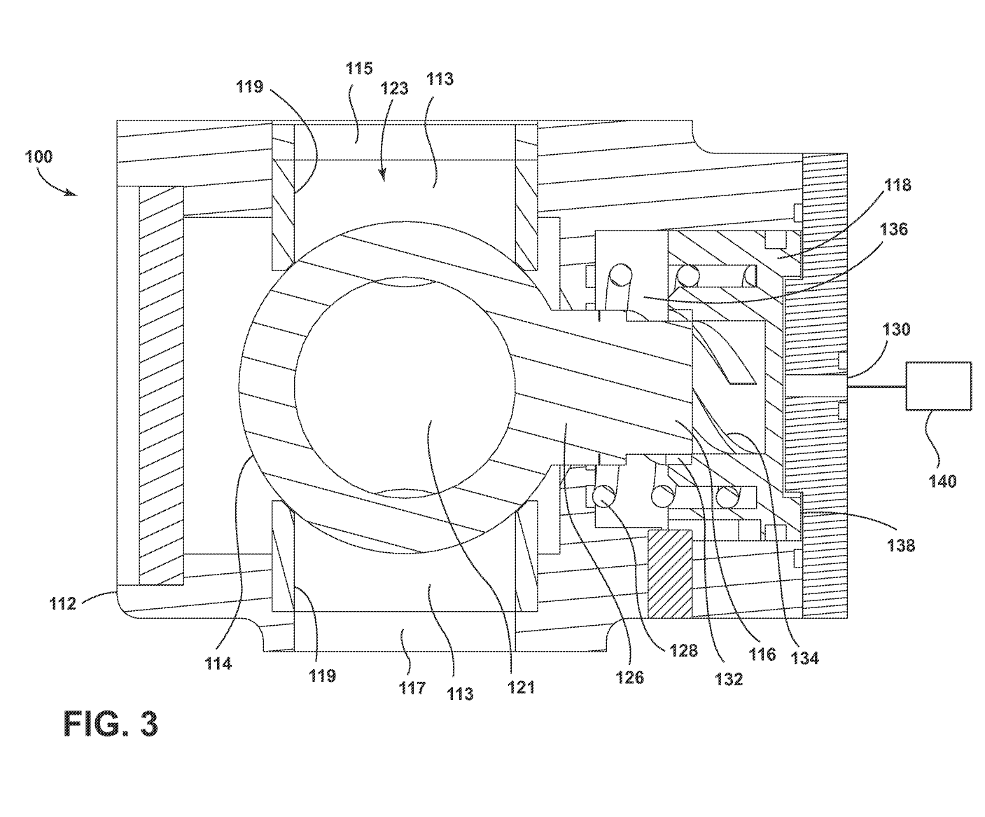

The second embodiment of the ball valve assembly 100 has several differences from the first embodiment with respect to the details of the rotation converter 116 and linear actuator 118. The salient differences will be described. The rotation converter 116 comprises a stem 126 in communication with the ball 114 that extends through a stem passage in communication with the chamber 113 defined by an opening in the ball seat 119 that is substantially perpendicular to the flow passage 123. The stem 126 comprises a first screw thread 132 disposed on the stem 126 that is complementary with a second screw thread 134 (best seen in FIG. 3), disposed on the linear actuator 118, where the stem 126 and complementary screw threads 134 and 132 define a rotation converter 116.

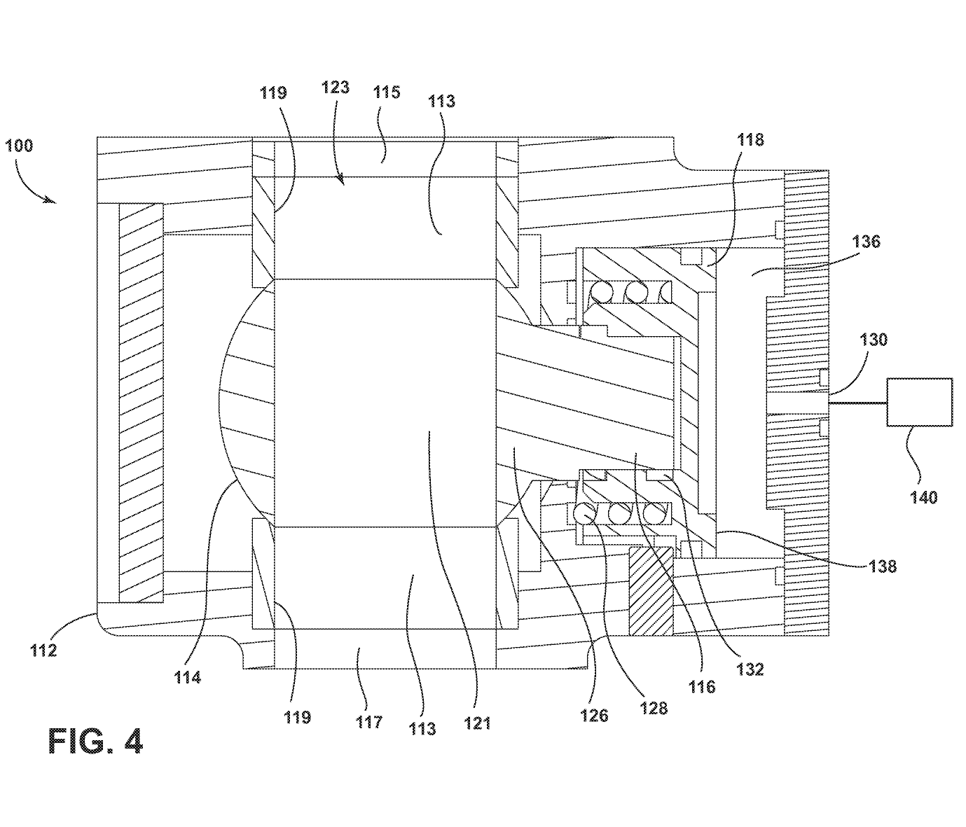

The linear actuator 118 is disposed in a piston chamber 136 formed in the housing 112 and comprises a piston 138 linearly movable between at least a first position, depicted in FIG. 4, and second position depicted in FIG. 3. The piston chamber 136 may also form at least a portion of the stem passage and may encompass at least a portion of the stem 126. The piston 138 further comprises the second screw thread 134, shown in FIG. 3, complementary to the first screw thread 132 disposed on the stem 126. A biasing element, a biasing spring 128, configured to normally bias the piston 138 to the second position is in communication with the piston 138. Furthermore, the piston 138 and piston chamber 136 are in communication with a fluid inlet 130 formed in the housing 112 configured to receive a pressurized fluid.

The operation of the ball valve assembly 100 will be described with respect to FIGS. 3 and 4. For purposes of the description, it is assumed that the ball valve assembly 100 begins in the second or closed position as illustrated in FIG. 3. Pressurized fluid supplied by a fluid source 140 entering the fluid inlet 130 exerts pressure on the piston 138. By exerting a pressure having a magnitude sufficient to overcome the spring force of the biasing spring 128, the piston 138 linearly moves from the second or closed position depicted in FIG. 3 to the first or open position depicted in FIG. 4. The linear movement of the piston 138 is translated into rotational movement by the complementary screw threads 134 and 132 and is imparted on the stem 126. The stem 126 and the complementary screw threads 134 and 132 defining the rotation converter 116 are configured such that a stem 126 rotation in the range of 90 degrees corresponds to the linear movement of the piston 138 from the second position depicted in FIG. 3 to the first position depicted in FIG. 4. Referring now to FIG. 4, as the stem 126 rotates, the ball 114 in communication with the stem 126 also rotates. When the piston 138 is in the first position, the through passage 121 of the ball 114 is substantially aligned with the flow passage 123 in the housing 112, defining an open position thereby allowing flow to occur through the flow passage 123.

When the pressurized fluid supplied by the fluid source 140 ceases to enter the fluid inlet 130, the spring force of the biasing spring 128 is exerted on the piston 138 causing the piston 138 to linearly move from the first position depicted in FIG. 4 to the second position depicted in FIG. 3. The linear movement of the piston 138 is translated into rotational movement by the complementary screw threads 134 and 132 and is imparted on the stem 126. Referring again to FIG. 3, as the stem 126 rotates, the ball 114 in communication with the stem 126 also rotates. When the piston 138 is in the second position, the through passage 121 of the ball 114 is substantially misaligned with the flow passage 123 in the housing 112, defining a closed position and thereby not allowing flow to occur through the flow passage 123.

Furthermore, by controlling the pressure of the pressurized fluid supplied by the fluid source 140 relative to the spring force of the biasing spring 128, it is possible to linearly move the piston 138 to a plurality of positions between the first and second positions. Each position of the piston 138 corresponds to a degree of alignment between the through passage 121 of the ball 114 and the flow passage 123 of the housing 112. In this way, the area of the opening between the through passage 121 and the flow passage 123 is controlled, thereby effectively controlling the flow rate of the fluid flowing through the flow passage 123.

In another embodiment according to the innovation, the piston chamber 136 may have fluid inlets and outlets disposed on opposite sides of the piston 138 so as to eliminate the need for a biasing spring 128. Fluid pressure selectively supplied and released to the piston chamber 136 on opposite sides of the piston 138 through the fluid inlets and outlets may be used to effect the linear movement of the piston 138 and correspondingly effect the position of the ball 114 through passage 121 relative to the flow passage 123 of the housing 112, thereby effectively controlling the flow rate of the fluid flowing through the flow passage 123.

It will be understood that the rotation converter may comprise any suitable channel and follower, not just the complementary threads as illustrated, wherein the channel is located on one of the actuating element and stem and the follower is located on the other of the actuating element and stem. In one example, but not by way of limitation, the channel comprises at least one pin. It will also be understood that the fluid pressure used to actuate the actuating element may be in the form of, but not limited to, hydraulics or pneumatics and the actuating element may be configured to actuate at a broad range of applied fluid pressures. It will further be understood that the ball valve assembly may be used in any application where flow rate control of any fluid is desired.

The embodiments described above provide for a variety of benefits including that the embodiments allow for compact and light weight ball valve assembly by encompassing the actuating element and ball in a single housing. Further, the ball valve assembly may be actuated in the absence of electricity or human intervention, providing greater flexibility with respect to mounting locations and application environment.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the innovation, including the best mode, and also to enable any person skilled in the art to practice the innovation, including making and using any devices or systems and performing any incorporated methods. The patentable scope of the innovation is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A ball valve assembly comprising:
a housing defining a ball seat in the form of a chamber, an inlet in communication with the chamber, an outlet in communication with the chamber, and a stem passage in communication with the chamber, wherein the inlet, chamber, and outlet define a flow passage through the housing;
a ball having a through passage and a stem extending from the ball, with the ball being seated within the ball seat and the stem extending through the stem passage, wherein rotation of the stem between an open position and a closed position effects the alignment and nonalignment, respectively, of the through passage with the flow passage to control the flow of fluid through the through passage;
a linear actuator having a piston linearly movable between first and second positions;
a rotation converter coupling the piston to the stem and converting the linear movement of the piston into a rotational movement of the stem;
wherein actuation of the linear actuator effects the relative linear movement of the piston between the first and second positions to effect a corresponding relative rotational movement of the stem between the open and closed positions to control the relative alignment of the through passage with the flow passage and thereby controlling the flow of fluid through the flow passage.

2. The ball valve assembly of claim 1 wherein the housing defines a piston chamber in which the piston is received.

3. The ball valve assembly of claim 2 wherein the housing further comprises a fluid inlet and fluid outlets to the piston chamber and on opposite sides of the piston whereby fluid pressure may be used to effect the linear movement of the piston.

4. The ball valve assembly of claim 3 wherein the piston chamber forms at least a portion of the stem passage.

5. The ball valve assembly of claim 1 wherein the rotation converter comprises a complementary channel and follower.

6. The ball valve assembly of claim 5 wherein the channel is located on one of the piston and stem and the follower is located on the other of the piston and stem.

7. The ball valve assembly of claim 5 wherein the follower comprises at least one pin.

8. The ball valve assembly of claim 5 wherein the follower comprises a first screw thread.

9. The ball valve assembly of claim 8 wherein the channel comprises a second screw thread complementary to the first screw thread.

10. The ball valve assembly of claim 1 further comprising a biasing element to bias the piston to the second position such that the ball is normally maintained in a closed position.

11. A ball valve assembly comprising:
a housing defining a ball seat in the form of a chamber, an inlet in communication with the chamber, an outlet in communication with the chamber, and a stem passage in communication with the chamber, wherein the inlet, chamber, and outlet define a flow passage through the housing;
a ball having a through passage and a stem extending from the ball, with the ball being seated within the ball seat and the stem extending through the stem passage, wherein rotation of the stem between an open position and a closed position effects the alignment and nonalignment, respectively, of the through passage with the flow passage to control the flow of fluid through the through passage;
a pneumatic actuator having an actuating element linearly movable between first and second positions;
a rotation converter coupling the actuating element to the stem and converting the linear movement of the actuating element into a rotational movement of the stem;
wherein actuation of the pneumatic actuator effects the relative linear movement of the actuating element between the first and second positions to effect a corresponding relative rotational movement of the stem between the open and closed positions to control the relative alignment of the through passage with the flow passage and thereby controlling the flow of fluid through the flow passage.

12. The ball valve assembly of claim 11 at least partially encompasses the stem.

13. The ball valve assembly of claim 12 wherein the rotation converter comprises a complementary channel and follower, wherein the channel is located on one of the actuating element and stem and the follower is located on the other of the actuating element and stem.

14. The ball valve assembly of claim 13 wherein the follower comprises at least one of: at least one pin, or at least one screw thread.

15. The ball valve assembly of claim 1 further comprising a biasing element to bias the actuating element to the second position such that the ball is normally maintained in a closed position.
